(19) United States
(12) Patent Application Publication
(10) Pub. No.: US 2025/0260956 A1
(43) Pub. Date: Aug. 14, 2025

(54) METHODS, APPARATUSES AND COMPUTER PROGRAMS FOR SENSING INITIATOR, EFFECTUATOR, AND RESULT CONSUMER

(71) Applicant: Telefonaktiebolaget LM Ericsson (publ), Stockholm (SE)

(72) Inventors: Guido Roland HIERTZ, Aachen (DE); Miguel LOPEZ, Solna (SE); Leif WILHELMSSON, Lund (SE); Hugo TULLBERG, Nyköping (SE)

(21) Appl. No.: 18/856,803

(22) PCT Filed: Apr. 26, 2022
(86) PCT No.: PCT/EP2022/061090

§ 371 Date: Oct. 14, 2024

(51) Int. Cl. H04W 4/38; H04L 5/00; H04W 24/10

(52) U.S. Cl. CPC H04W 4/38; H04L 5/0051; H04W 24/10

(57) ABSTRACT

Methods for sensing through observing radio channel properties in a radio communication network. One of the methods is performed by a responding station, another is performed by an initiating station, and still another is performed by a result consuming station arranged to actuate something based on the result. The initiating station transmits an initiating message the responding station. The initiating message includes attributes for a sensing operation. The responding station causes reception of a signal transmitted over a radio channel in the radio communication network, and causes transmission of a response message having response information based on radio channel properties of the radio channel and formed based on the attributes for the sensing operation. The result consuming station receives the response message and provides a control signal through an output interface.

### TECHNICAL FIELD

The present disclosure generally relates to sensing through observing radio channel properties in a radio communication network. In particular, the disclosure relates to approaches therefor for a sensing initiator, a sensing effectuator, and a sensing result consumer. The approaches are described to be realized through methods, apparatuses and computer programs.

### BACKGROUND

Wireless communication solutions have been around for a long time. Through the history of wireless communication technology higher and higher frequencies have come into use. Lately, the used frequencies, and bandwidths, have been sufficient for use also for wireless sensing. Wireless sensing per se has been known for a long time, e.g., radar. However, such dedicated sensing approaches have evolved in their own way, while the use of communication systems also for sensing is a relatively new field of technology. Terms such as Joint Communication and Sensing have shown up, and different communication approaches have been investigated for feasible solutions for sensing.

One communication approach is WiFi which is defined through IEEE 802.11 which is traditionally used for providing a Wireless Local Area Network (WLAN). The IEEE 802.11 flavour IEEE 802.11bf defines an amendment for wireless sensing. IEEE 802.11bf will define methods for exchanging IEEE 802.11 transmissions (denoted as frames) between IEEE 802.11bf compliant devices (stations, STAs). The frame exchanges enable STAs to sense their environment. With wireless sensing, STAs are capable to detect motion, the presence of human beings and pets, the position of doors (open, closed), and potentially aspects like pulse rate and respiratory rate.

IEEE 802.11bf introduces so-called “WLAN sensing procedures”. Such procedures enable a STA to perform sensing and/or obtain measurement results. A WLAN sensing procedure comprises one or more of: sensing session setup, sensing measurement instance, sensing measurement setup termination, and sensing setup termination. A STA that initiates a sensing procedure is called a sensing initiator, while a STA that participates in a sensing procedure started by an initiator is called a sensing responder. A sensing transmitter is a STA that transmits physical layer protocol data units (PPDU) used for sensing measurements, and a sensing receiver is a STA that receives a PPDU transmitted by a sensing transmitter and performs measurements in a WLAN sensing procedure. A STA can have multiple roles in a WLAN sensing procedure. In a sensing session setup, the operational parameters associated with the sensing session are determined and exchanged among STAs.

When the sensing receiver is not consuming the measurements, it sends a sensing measurement report frame to report the measurements. A sensing measurement report frame comprises a measurement report field which carries CSI measurements obtained by a sensing receiver, and a control field that contains information describing how to interpret the measurement report field. Examples of information needed to interpret the CSI measurements include resolution (in bits), bandwidth and number of RX chains.

The above information disclosed in this Background section is only for enhancement of understanding of the background of the disclosure and therefore it may contain information that does not form the prior art that is already known to a person of ordinary skill in the art.

### SUMMARY

The IEEE 802.11bf draft amendment specifies the behaviour of sensing initiators, transmitters, receivers, and proxies. In any case, IEEE 802.11bf STAs exchange channel state information (CSI) that is subject to interpretation. CSI helps to identify variation in the channel representative of motion and other occurrences in the wireless environment. At present, the IEEE 802.11bf draft amendment lacks a means of exchanging the result of a sensing measurement, however. Thus, a STA A cannot indicate to a STA B the conclusions that STA A drew from a channel sensing measurement. Consequently, an IEEE 802.11bf STA cannot indicate to other STAs that it detected motion in a room, the presence of a number of human beings in a room, a person's breathing rate, or similar, abstract measurement results.

As a specific example, consider a situation when a sensing initiator is also the sensing transmitter. This means that the initiator sends packets intended for sensing to the sensing receiver, which in turn report back the CSI. The CSI may then e.g. be used by the sensing initiator to determine whether the change in the CSI between two consecutive sensing packets exceeds a threshold. In this case, the value of the CSI is not at all if any interest, but it is merely whether the change is large or not. This means that although the outcome of the sensing is only binary, the CSI report may be very large.

In IEEE 802.11bf this problem has been partly identified and as a means to reduce the amount of CSI data that has to be sent, the sensing receiver may use a threshold for when CSI data should be sent. Specifically, the sensing receiver only sends CSI data when it is sufficiently different than the CSI data for the previous sensing event. Clearly this may significantly reduce the amount of data that needs to be sent, but it still comes with two short-comings. First, even if the sensing initiator is only interested in a binary decision, the packet sent to indicated this contains the full CSI report. Second, in case the CSI change is very small for a long time there will be no feedback sent from the sensing receiver. This means that the sensing initiator does not know if the sensing receiver is still operating. To make sure the sensing receiver is still active, the sensing initiator therefore has to request the sensing receiver to send packets at regular intervals just to indicated that it is still available.

The disclosure is based on the inventors' realization that there is a need for a more efficient and lean way of initiating, providing and consuming the sensing and the results thereof.

This is provided by an approach for exchanging and distributing the result of channel sensing measurements in a radio (RLAN) or wireless local area network (WLAN). In the following, we use the term RLAN as an equivalent to the terms WLAN, Wi-Fi network, or IEEE 802.11 network. The described approach may be also used to distribute the results of channel measurements over the Internet or via Cloud-based computing solutions.

The approaches allow for a sensing transmitter to request the sensing receiver to send a reduced amount of data back (or to any consumer of the result) by letting the sensing receiver take a partial or a full decision based on the results of the sensing. This may also be combined with the threshold-based approach already supported by the 802.11bf specification and discussed above.

The disclosure proposes to transmit, indicate, provide, or signal the result of wireless sensing measurements instead of only to transmit, indicate, provide, or signal the underlying measurement data itself. It is proposed that the initiator of the sensing provides this through attributes linked to the sensing task.

According to a first aspect, there is provided a method of sensing through observing radio channel properties in a radio communication network. The method is performed by a responding station operating in said radio communication network, where transmission operations in said radio communication network is performed in lower layers, comprising physical layer and data link layer, and higher layers, comprising layers above the data link layer. The method comprises receiving an initiating message from an initiating station, wherein the initiating message comprises attributes, the attributes being obtained from lower layers of the initiating message, for a sensing operation. The method further comprises receiving, through at least one sensing station associated with the responding station, at least one signal transmitted over at least one radio channel in the radio communication network. The method includes causing transmission of a response message comprising response information based on radio channel properties of the at least one radio channel, wherein the response information is comprised in higher layers of the response message and what information the response message holds depends on the attributes for the sensing operation.

The attributes for the sensing operation may include an indication on a measurement report, and the response information may be formed as a report type according to the measurement report. The attributes may comprise an indicator for indicating whether the measurement report is proprietary. The attributes may comprise type information about the report type of the measurement report. The type information about the report type of the measurement report may indicate that received samples corresponding to reference signals are to be included in the response, or alternatively may indicate that a processed result of the radio channel properties is to be included in the response information. The type information about the report type of the measurement report may indicate that the response information with the processed result is only to be sent when criteria of the processed result is achieved.

The responding station may be a sensing station.

The transmission of a response message may be performed in form of a broadcast message.

The transmission of a response message may be performed in form of any one of a multi-cast message and one or more unicast messages. The multi-cast or unicast messages may be addressing entities based on a subscription.

The causing of the transmission of response information may be halted until a change of response in view of a prior transmitted response exists.

According to a second aspect, there is provided a wireless device comprising a transceiver and a controller, wherein the controller is arranged to cause the wireless device to perform, by the transceiver, the method of the first aspect.

The first and second aspects are related to the sensing effectuator discussed above. The somewhat uncommon term “effectuator” is herein used for its meaning “a thing that brings about an event or result”, i.e. the responding station either does the measurements itself or causes associated stations or entities for performing the measurements.

According to a third aspect, there is provided a method of initiating sensing, which sensing is performed through observing, by a sensing station, radio channel properties in a radio communication network. The method is performed by an initiating station operating in said radio communication network, where transmission operations in said radio communication network is performed in lower layers, comprising physical layer and data link layer, and higher layers, comprising layers above the data link layer. The method comprises transmitting an initiating message from an initiating station to a responding station associated with the sensing station, wherein the initiating message comprises attributes for a sensing operation, the attributes being comprised in lower layers of the initiating message. The method also comprises causing at least one transmitting station to transmit at least one signal over at least one radio channel in the radio communication network.

The attributes for the sensing operation may indicate a response message form where response information is comprised in higher layers of a response message.

The method may comprise receiving a response message comprising response information from the responding station or a sensing station, where the response information has form based on the attributes for the sensing operation and the response information is comprised in higher layers of the response message.

The attributes for the sensing operation may include an indication on a measurement report, and the response may have form as a report type according to the measurement report. The attributes may comprise an indicator for indicating whether the measurement report is proprietary. The attributes may comprise type information about the report type of the measurement report. The type information may indicate that received samples corresponding to reference signals are to be included in the response. The type information may indicate that a processed result of the radio channel properties is to be included in the response. The type information may indicate that the response with the processed result is only to be sent when criteria of the processed result are achieved.

The initiating station may also be the transmitting station.

The responding station may also be the sensing station.

The responding station may be an access point station. The sensing station may comprise one or more stations associated with a basic service set of the access point.

According to a fourth aspect, there is provided a wireless device comprising a transceiver and a controller, wherein the controller is arranged to cause the wireless device to perform, by the transceiver, the method of the third aspect.

The wireless device may be a station operating in said radio communication network, wherein the radio communication network is a wireless local area network.

The third and fourth aspects are related to the sensing initiator discussed above.

According to a fifth aspect, there is provided a computer program comprising instructions which, when executed on a processor of a wireless device causes the wireless device to perform the method according to any of the first and third aspects.

According to a sixth aspect, there is provided a method of consuming result achieved remotely through sensing through observing radio channel properties in a radio communication network. The method is performed by an actuating station operating in said radio communication network. The method comprises receiving a response message comprising response information of a sensing operation, and providing a control signal through an output interface. The control signal is depending on the response of the received message.

Transmission operations in the radio communication network may be performed in lower layers, comprising physical layer and data link layer, and higher layers, comprising layers above the data link layer. Attributes may be obtained from lower layers of an initiating message, and the response information may have form based on the attributes, and the response information may be comprised in higher layers of the response message.

The control signal may comprise information for switching on or off one or more devices being in connection with the output interface. The one or more devices may comprise one or more mechanical or electrical elements being actuated by the control signal. The one or more devices may comprise one or more access points being switched on or off for communication operation.

The reception of the response message may be performed in form of receiving a broadcast message.

The reception of the response message may be performed in form of receiving any one of a multi-cast message and one or more unicast messages. The multi-cast or unicast messages may be addressing entities based on a subscription, and the method may comprise setting up a subscription for the response of the sensing operation.

According to a seventh aspect, there is provided a wireless device comprising a receiver and an output interface, wherein the wireless device to perform the method of the sixth aspect.

The wireless device may be a station operating in said radio communication network, wherein the radio communication network may be a wireless local area network.

The output interface may comprise a wireless transmitter for providing the control signal.

The output interface may comprise a wired connection point for providing the control signal.

According to an eighth aspect, there is provided a computer program comprising instructions which, when executed on a processor of a wireless device causes the wireless device to perform the method according to the sixth aspect.

### BRIEF DESCRIPTION OF THE DRAWINGS

The above, as well as additional objects, features and advantages of the present disclosure, will be better understood through the following illustrative and non-limiting detailed description of preferred embodiments of the present disclosure, with reference to the appended drawings.

FIG. 1 schematically illustrates an example of a sensing procedure.

FIG. 2 illustrates different trigger-based sensing measurement instances.

FIG. 3 is a flow chart illustrating a method for a sensing effectuator according to an embodiment.

FIG. 4 is a flow chart illustrating a method for a sensing initiator according to an embodiment.

FIG. 5 is a flow chart illustrating a method for a sensing result consumer according to an embodiment.

FIG. 6 is a signal diagram illustrating examples of signal interaction between entities included in sensing operations.

FIG. 7 is a block diagram schematically illustrating any of a sensing initiator device, a sensing effectuator device, and a sensing result consumer device according to embodiments.

FIG. 8 schematically illustrates a computer-readable medium and a processing device.

FIG. 9 illustrates a wireless network including network nodes and a wireless communication device.

### DETAILED DESCRIPTION

The present disclosure describes a method of signaling the result of wireless sensing measurements in RLANs. Having performed, conducted, responded to, participated in, observed, overheard, or detected a wireless sensing measurement, which might follow the procedures described in the IEEE 802.11bf amendment of the IEEE 802.11 standard, a STA signals, transmits, indicates, stores, provides, computes, or estimates the result of the wireless sensing measurement. The result of a wireless sensing measurement may be denoted as follows:
Human being detected
   Estimated number of human beings detected
Motion detected
   Estimated source of motion
      Human being
      Animal
      Robot
      Vehicle
      Curtain, fabrics, thing, matter
   Estimated number of sources of motion
   Type of motion
      Walking
      Jumping
      Crawling
      Falling
      Approaching or leaving a door, room, or building
      Passing by a door, room, or building
   Speed of motion
Change in the position of a door, garage door, gate or similar
   Door closed
   Door opened
      Angle at which the door is opened
      Percentage of door passage opened
Smoke, fire or other, hazardous event detected
Water detected
   Estimated volume of water flowing per time interval
Rain detected
   Estimated volume of rain per time interval and area
Estimated pulse, respiratory rate of a human being or animal
Gestures detected
   Type of gesture
   Direction of gesture
   Speed of gesture
   Etc.
Presence or absence of an item (car, bicycle, furniture etc.)
Other aspects

For each indicated wireless sensing measurement result, the STA may or may not provide a confidence level. This helps receiving STAs to decide if the estimated wireless sensing measurement result may be relied upon.

STAs may send wireless sensing measurement results individually or group addressed (including the broadcast address). Furthermore, STAs may transmit wireless sensing measurement results on request.

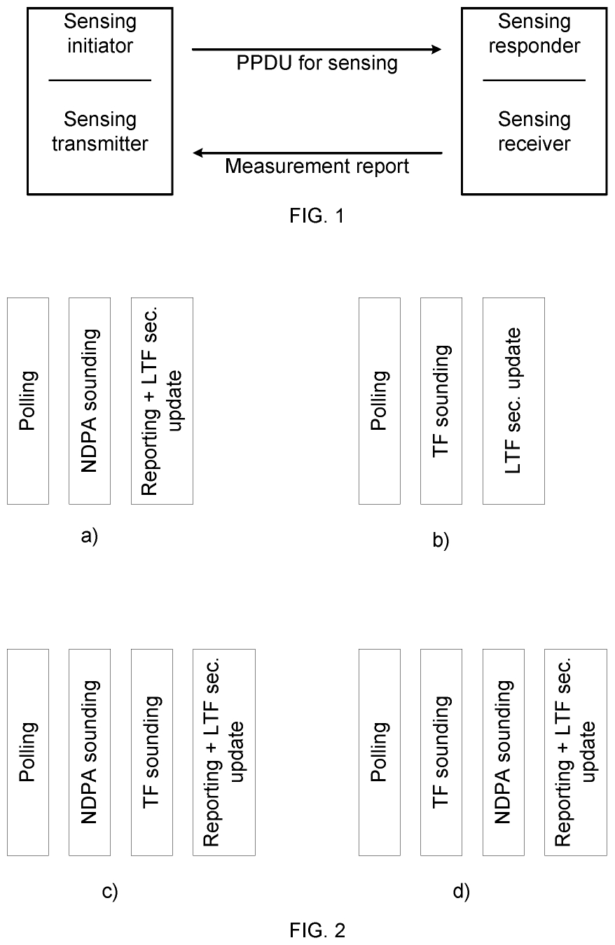

FIG. 1 exemplifies a WLAN sensing procedure where the sensing responder is also a sensing receiver, and the initiator is also a sensing transmitter. In this case the sensing initiator sends one or more PPDUs for sensing, the responder receives the packets, performs measurements (e.g., estimates CSI), i.e. effectuates the sensing, and feeds back a measurement report to the initiator (or to any other sensing result consumer). The sensing initiator in the illustrated example also consumes the measurement reports, that is, in this example the sensing initiator is also a sensing result consumer.

STAs may send wireless sensing measurement results individually or group addressed (including the broadcast address). Furthermore, STAs may transmit wireless sensing measurement results on request.

If the herein described approach is applied with IEEE 802.11 implementations, the wireless sensing measurement results may be signalled in elements, information elements, and actions frames. When the wireless sensing measurement results are presented to entities residing in layers above layer 2 (Medium Access Control (MAC) layer) of the ISO/OSI reference model, or when the wireless sensing measurement results are presented to a MAC Layer Management Entity (MLME) or Station Management Entity (SME), the wireless sensing measurement results may be presented through a Service Access Point (SAP).

In one embodiment of the disclosure, the sensing initiator performs a sensing measurement setup where it specifies that the sensing measurement report frames shall be proprietary. This could be accomplished for example by defining a sensing measurement information element comprising a report type. Alternatively, the report type can be announced by the initiator during the session setup. The difference is that a session may comprise several measurement setups. Thus, defining the report type during the measurement setup allows the initiator to change the report type during the duration of a sensing session, at the cost of increased overhead.

It is proposed to enhance the measurement control field to indicate whether the report is proprietary, and optionally to include fields to interpret the sensing measurement report frame. Another option is to implicitly or explicitly indicate in the measurement control field how to re-interpret the information in the measurement control field. For example, the report type could be one bit indicating whether the report is proprietary.

One example of proprietary report is to feed back the received I/Q samples corresponding to the long training fields. This would allow the initiator to perform the CSI calculation itself, which may be advantageous as it can apply its own algorithms optimized for the sensing task at hand. In this case, the resolution field indicating the number of bits for CSI reporting can be re-interpreted as the resolution of the I/Q samples whenever the report type indicates “proprietary report”.

Other examples of proprietary report comprise the reporting directly the result of the sensing. In this case the sensing receiver consumes the CSI. It utilizes the CSI to perform a sensing task, such as any of those mentioned above (e.g., motion detection, humans detected, door opened, etc.) and transmits this result in the measurement report. Note that in many cases the result of the sensing can be communicated with fewer bits than the CSI and fewer measurement reports. For example, binary results (e.g., humans detected yes/no, or door open/closed) require only one bit. Moreover, the detection of events (e.g., person fell) often requires the CSI from several sensing PPDUs, and hence require several sensing measurement reports. In contrast, if a proprietary report comprising the detection result is used, then only one sensing measurement report is needed, thus reducing the traffic load on the wireless medium.

In some cases, the initiator may want to receive measurement reports even if the responder has nothing to report. For example, the initiator may want to check periodically whether the responder is active and has not been tampered with. An information element specifying a minimum number of measurement reports can be negotiated during the sensing session setup or measurement setup. For example, the receiver may be asked to send at least one sensing measurement report for every N sensing PPDUs received (where N is an arbitrary integer selected by the initiator).

One of the features introduced in IEEE 802.11bf is sensing by proxy (SBP). SBP means that a non-AP STA can request the AP it is associated with to perform take care of the actual sensing procedure. The non-AP STA is in this case the initiator, but may not itself take any active part in the actual sensing process. In this case, the AP can perform sensing with other non-AP STAs, either as a sensing transmitter or a sensing receiver, and then report the sensing results back to the initiating STA.

The major advantage with SPB is that an AP typically has the ability to obtain much more sensing data than a non-AP STA. This is readily seen since a non-AP STA performing sensing measurement would do this for the channel between the AP and itself, whether taking the role as sensing transmitter or sensing receiver. The AP, on the other hand, will effective be able to perform sensing measurements on the channels to all associated STAs. So, if an AP has 10 associated STAs, the AP can collect sensing data obtained from 10 channel measurements, whether the AP is taking the role as sensing transmitter or sensing receiver.

According to this embodiment, when SBP is employed, the initiating STA will request the AP to provide an appropriate sensing result in a similar fashion as described in the previous embodiment when the initiating STA was involved in the actual sensing measurement. Several options are possible and are within the scope of this embodiment. Some examples are listed below:
The initiating STA requests the AP to provide a binary value (e.g., movement detected or no movement detected) at regular intervals.
The initiating STA requests the AP to inform the initiating STA only if something has happened (e.g., there has been some movement).
The initiating STA requests the AP to inform the initiating STA about where there has been movement detected. This could e.g., correspond to a situation where the AP performs the sensing measurement by involving 10 different STAs, and where movement detection is determined individually for the 10 channels corresponding to these 10 STAs. The initiating STA may know the location of the 10 different STAs and can in this way determine where in the environment there has been movement.
The initiating STA may request the AP to provide an indication of the total movements that are detected in the environment by in some way take into account the movements detected for the 10 different channels. This indication may e.g. be an integer between 0 and 10 indicating how many of the STAs involved in the sensing have reported a noticeable movement.
The initiating STA may request the AP to provide detailed reports from each one of the STAs engaged in the sensing. For the example with 10 STAs engaged in the sensing, this could for example mean that the initiating AP would obtain 10 different reports where each of the reports would indicate the amount of movement detected on a scale from, say, 1 to 5.

It might be possible to implement IEEE 802.11bf on existing IEEE 802.11 products. However, IEEE 802.11bf may not be implemented in existing products because of business or financially related aspects. Nevertheless, it will be helpful for existing products to learn of the results of wireless sensing measurements that other IEEE 802.11 devices performed. Furthermore, very energy-efficient IEEE 802.11 devices may be too constrained to conduct IEEE 802.11bf measurements themselves or to conduct the computations necessary to draw conclusion from CSI received from other IEEE 802.11 devices. Therefore, many IEEE 802.11 devices exist that benefit from having knowledge of the sensing measurement results conducted by other IEEE 802.11 devices.

According to this embodiment, STAs involved wireless sensing may distribute the result of wireless sensing to other STAs. These other STAs may or may not be associated with the same Basic Service Set (BSS) that the wireless sensing STAs belong to. The result of a wireless sensing measurement may be sent as individually or group-addressed (multicast and broadcast) message. The (reliable) transmission of group-addressed messages is described in today's IEEE 802.11 standard and its amendments. Hence, sensing result consumers or sensing result consuming STAs describe a third category of wireless sensing devices.

Sensing result consumers are do not process low-level CSI messages. Instead, sensing result consumers rely on other devices to draw conclusions from wireless sensing messages and might act or react on the indicated results. Since wireless sensing result messages may be carried in existing IEEE 802.11 messages (data frames, actions frames, Information Elements etc.), simple software (firmware) upgrades of legacy IEEE 802.11 equipment empower it to understand and process incoming messages.

Furthermore, wireless sensing consumers may transmit abstract messages to other AP and non-AP STAs that are IEEE 802.11bf capable or in connection with IEEE 802.11bf capable devices. These abstract messages may invite, instruct, or request a certain measurement to be conducted. For example, a legacy IEEE 802.11 device may request an IEEE 802.11bf capable AP to determine the number of human beings in a room. Having conducted the requested measurement or having invited other, IEEE 802.11bf capable devices to conduct the measurement (see proxy devices), the device instructed will inform the requesting device about the measurement results obtained.

Furthermore, sensor devices might subscribe to certain wireless sensing result message streams. A wireless sensing result message stream may be described as “Change of the number of human beings in the measured area” or “Door open.” Whenever an event occurs that belongs to the described message stream, a message is sent to a particular group address informing all devices that subscribe to this message stream. Such a mechanism may help low-power, very energy-efficient, latency tolerant sensors that consume messages but are incapable to otherwise process or conduct wireless sensing measurements by themselves.

Another advantage of the proposed embodiment is that existing BSSs may become benefit from IEEE 802.11bf by the simple addition of two devices capable IEEE 802.11bf-capable devices that perform wireless sensing measurements and share the results as abstract, high-level messages. In this case, existing legacy, IEEE 802.11bf-incapable AP STAs may continue to be used in the BSS, since these legacy AP STAs are only required to relay or transfer wireless sensing result messages between associated non-AP STAs.

FIG. 2 illustrates different trigger-based sensing measurement instances suggested in draft Specification Framework for TGbf as of 24 Jan. 2022, which is hereby incorporated by reference in its entirety. In a polling phase, an access point (AP) sends a trigger frame to check availability of STAs. A null data packet (NDP) announcement (NDPA) sounding phase comprises transmission of a sensing NDPA frame by an AP, and transmission of an NDP by an AP a short interframe spacing (SIFS) after the transmission of the sensing NDPA frame. A trigger frame sounding phase comprises transmission of a trigger frame by an AP to solicit NDP transmission(s) from STA(s), and transmission of an NDP by STA(s) SIFS after receiving the trigger frame. In a reporting phase of a sensing measurement instance, sensing measurements are reported. For non-trigger-based sensing measurement instances, a non-AP STA is sensing initiator and an AP is sensing responder.

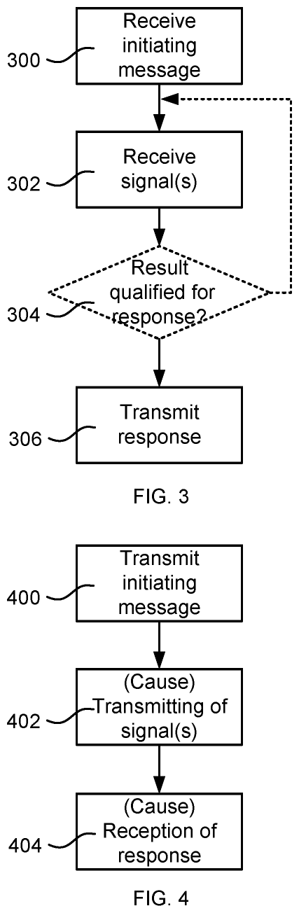

FIG. 3 is a flow chart illustrating a method of sensing through observing radio channel properties in a radio communication network. The method is performed by a responding station operating in said radio communication network. The responding station receives 300 an initiating message from an initiating station, wherein the initiating message comprises attributes for a sensing operation. The attributes for the sensing operation may include an indication on a measurement report, and the response is formed as a report type according to the measurement report. The attributes may comprise an indicator for indicating whether the measurement report is proprietary. The attributes may comprise information about the report type of the measurement report. The information about the report type of the measurement report may indicate that received samples corresponding to reference signals are to be included in the response, or indicate that a processed result of the radio channel properties is to be included in the response. The information about the report type of the measurement report may indicate that the response with the processed result is only to be sent when criteria of the processed result is achieved, as for example indicated through step 304 below. The responding station, either by itself or through one or more other sensing station associated with the responding station, receives 302 at least one signal transmitted over at least one radio channel in the radio communication network. The responding station can thus be a sensing station. The responding station can thus, based on radio channel properties of the at least one radio channel, either by itself or another associated station transmit 306 of a response formed based on the attributes for the sensing operation. The transmission of a response may be made in a broadcast message. Alternatively, the transmission of a response may be made in a multi-cast message or one or more unicast messages. The multi-cast or unicast messages may be addressing entities based on a subscription. The sensing result can thus be provided as a service. The result of the sensing, in view of the attributes, may not qualify 304 for transmission. In such cases, the receiving 302 of signals continues until a qualified result is achieved. A qualified result may be a result that deviates from an earlier transmitted result. For example, causing of the transmission of a response may be halted until a change of response in view of a prior transmitted response exists. Other criteria, such as reception quality, may also play a role in the qualification.

FIG. 4 is a flow chart illustrating methods of initiating sensing. As of above, the sensing is performed through observing by a sensing station radio channel properties in a radio communication network. The method is performed by an initiating station operating in the radio communication network. The method comprises transmitting 400 an initiating message from an initiating station to a responding station associated with the sensing station. The initiating station may be also the transmitting station. The responding station may also be the sensing station. More complex setups where associated stations to the initiating and responding station, respectively, handle the actual initiation transmission and sensing/transmitting of a response are equally possible. For example, the responding station may be an access point station, and the sensing station may comprise one or more stations associated with a basic service set of the access point.

The initiating message comprises attributes for a sensing operation. The attributes for the sensing operation may include an indication on a desired measurement report, e.g., what information should be returned from the sensing operation, and/or in what format. Optionally, the attributes comprise an indicator for indicating whether the measurement report is proprietary. The attributes may comprise information about a desired report type of the measurement report. The information about the report type of the measurement report may indicate that received samples corresponding to reference signals are to be included in the response. The information about the report type of the measurement report may indicate that a processed result of the radio channel properties is to be included in the response. The information about the report type of the measurement report may indicate that the response with the processed result is only to be sent when criteria of the processed result is achieved. This information may be used by the responding entity for the qualification 304 of the response.

The method also comprises transmitting, or causing an associated station to transmit 402 at least one signal over at least one radio channel in the radio communication network.

The method may comprise receiving 404 a response from the responding station or a sensing station, where the response has form based on the attributes for the sensing operation. The receiving 404 may also be made by another station which is the consumer of the result of the sensing operation. The response preferably has form as a report type according to the measurement report, or may include indications on what other report type the responding entity uses. The report type of the measurement report may be according to the provided attributes.

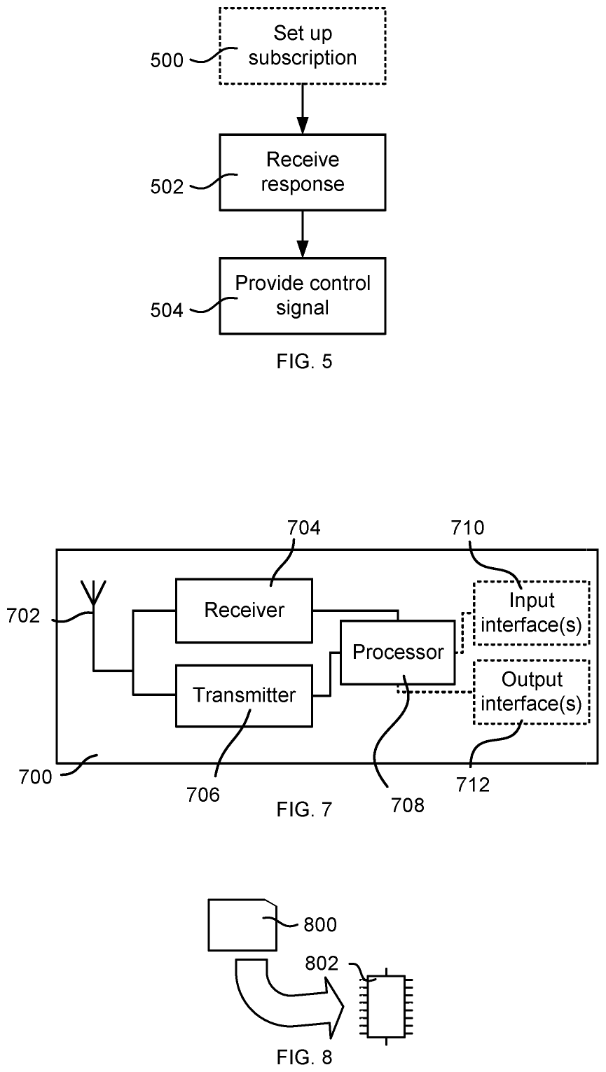

FIG. 5 is a flow chart illustrating a method of consuming result achieved remotely through sensing through observing radio channel properties in a radio communication network. The method is performed by an actuating station operating in the radio communication network. The method comprises receiving 502 a message comprising a response of a sensing operation, and providing 504 a control signal through an output interface. The control signal is depending on the response of the received message. The control signal may comprise information for switching on or off one or more devices being in connection with the output interface. The one or more devices may comprise one or more mechanical or electrical elements being actuated by the control signal. Alternatively, or additionally, the one or more devices comprise one or more access points being switched on or off for communication operation.

The method may comprise setting up 500 a subscription for the response of the sensing operation.

The message may be the response in form of a broadcast message. Alternatively, the reception of the message comprising the response is performed in form of receiving any one of a multi-cast message and one or more unicast messages. The multi-cast or unicast messages may be addressing entities based on a subscription.

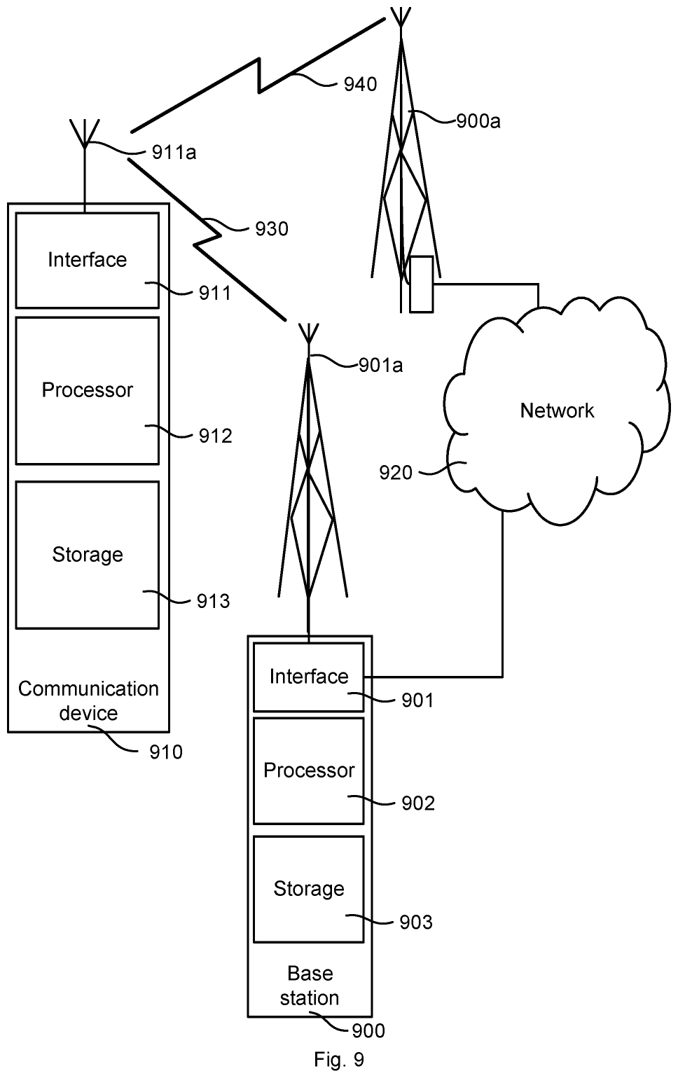

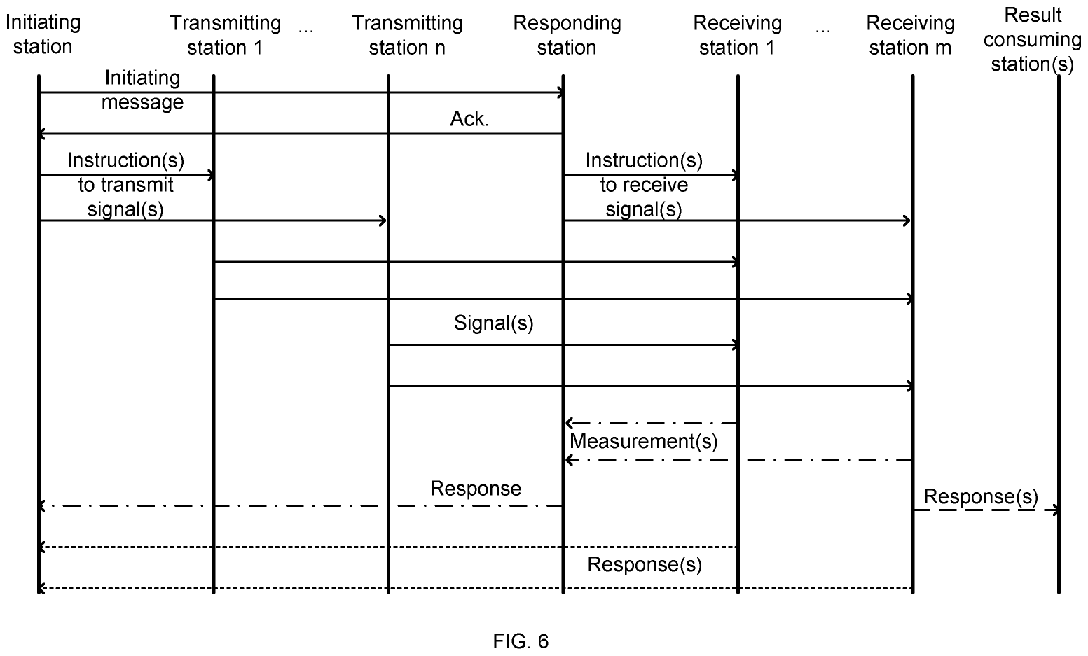

FIG. 6 is a signal diagram illustrating examples of operations between stations having different roles according to what has been demonstrated above. An initiating station transmits an initiating message to a responding station. According to some examples, the responding station acknowledges the initiating message. The acknowledgement procedure is optional, but may also comprise a more complex negotiation on the sensing task. The sensing operation is now considered set up. The responding statin may provide instructions to one or more receiving stations about the sensing operation. The initiating station may provide instructions to one or more stations to transmit signals on which the sensing can be made. The transmitting stations transmit signals which the receiving stations can use for the sensing. Sensing results can then be provided, either via the responding station, or directly from the receiving stations to a consumer of the sensing result, e.g., the initiating station or another station consuming the result as discussed above.

FIG. 7 is a block diagram schematically illustrating a station 700 according to an embodiment. The station 700 comprises an antenna arrangement 702, a receiver 704 connected to the antenna arrangement 702, a transmitter 706 connected to the antenna arrangement 702, a processing element 708 which may comprise one or more circuits, one or more input interfaces 710 and one or more output interfaces 712. The interfaces 710, 712 can be user interfaces and/or signal interfaces, e.g., electrical or optical. The station 700 is arranged to operate in a cellular communication network. In particular, by the processing element 708 being arranged to perform the embodiments demonstrated with reference to FIGS. 1 to 6, the station 700 is capable of taking the roles of an initiating station, a responding station, a result consuming station, or any of the transmitting and receiving stations. The processing element 708 can also fulfil a multitude of tasks, ranging from signal processing to enable reception and transmission since it is connected to the receiver 704 and transmitter 706, executing applications, controlling the interfaces 710, 712, etc.

In particular, where the station operates as a device for consuming the sensing result, the station 700 is a wireless device comprising a receiver 704 and an output interface 712, for performing the tasks as demonstrated with reference to FIG. 5. For example, the station 700 is operating in the radio communication network, and the radio communication network is a wireless local area network. The output interface 712 may comprise a wireless transmitter for providing the control signal, and or a wired connection point for providing the control signal. The output interface 712 may thus be connected to one or more mechanical or electrical elements being actuated by the control signal, and alternatively, or additionally, to one or more access points being switched on or off for communication operation. As an example of the operation of switching on or off access points for communication operation may be where the sensing result is that a crowd of potential users (people and/or machines) of communication services has gathered, additional access points are activated, and where the sensing result is that only few potential users of communication services are present, some access points may be switched off or go into low-power state.

The methods according to the present disclosure is suitable for implementation with aid of processing means, such as computers and/or processors, especially for the case where the processing element 708 demonstrated above comprises a processor handling the respective role the station takes. Therefore, there is provided computer programs, comprising instructions arranged to cause the processing means, processor, or computer to perform the steps of any of the methods according to any of the embodiments described with reference to FIGS. 3 to 6. The computer programs preferably comprise program code which is stored on a computer readable medium 800, as illustrated in FIG. 8, which can be loaded and executed by a processing means, processor, or computer 802 to cause it to perform the methods, respectively, according to embodiments of the present disclosure, preferably as any of the embodiments described with reference to FIGS. 3 to 6. The computer 802 and computer program product 800 can be arranged to execute the program code sequentially where actions of the any of the methods are performed stepwise, or be performed on a real-time basis. The processing means, processor, or computer 802 is preferably what normally is referred to as an embedded system. Thus, the depicted computer readable medium 800 and computer 802 in FIG. 8 should be construed to be for illustrative purposes only to provide understanding of the principle, and not to be construed as any direct illustration of the elements.

FIG. 9 illustrates a wireless network comprising network (NW) nodes 900 and 900a and a wireless device 910 with a more detailed view of the network node 900 and the communication device 910 in accordance with an embodiment. According to examples, the network nodes 900 operates as access point stations, and the wireless device 910 operates as a non-access point station. For simplicity, FIG. 9 only depicts core network 920, network nodes 900 and 900a, and communication device 910. Network node 900 comprises a processor 902, storage 903, interface 901, and antenna 901a. Similarly, the communication device 910 comprises a processor 912, storage 913, interface 911 and antenna 911a. These components may work together in order to provide network node and/or wireless device functionality as demonstrated above. In different embodiments, the wireless network may comprise any number of wired or wireless networks, network nodes, base stations, controllers, wireless devices, relay stations, and/or any other components that may facilitate or participate in the communication of data and/or signals whether via wired or wireless connections.

The network 920 may comprise one or more IP networks, public switched telephone networks (PSTNs), packet data networks, optical networks, wide area networks (WANs), local area networks (LANs), wireless local area networks (WLANs), wired networks, wireless networks, metropolitan area networks, and other networks to enable communication between devices. The network 920 may comprise a network node for performing the method demonstrated with reference to FIG. 8, and/or an interface for signalling between network nodes 900, 900a.

The network node 900 comprises a processor 902, storage 903, interface 901, and antenna 901a. These components are depicted as single boxes located within a single larger box. In practice however, a network node may comprise multiple different physical components that make up a single illustrated component (e.g., interface 901 may comprise terminals for coupling wires for a wired connection and a radio transceiver for a wireless connection). Similarly, network node 900 may be composed of multiple physically separate components (e.g., a NodeB component and an RNC component, a BTS component and a BSC component, etc.), which may each have their own respective processor, storage, and interface components. In certain scenarios in which network node 900 comprises multiple separate components (e.g., BTS and BSC components), one or more of the separate components may be shared among several network nodes. For example, a single RNC may control multiple NodeBs. In such a scenario, each unique NodeB and BSC pair, may be a separate network node. In some embodiments, network node 900 may be configured to support multiple radio access technologies (RATs). In such embodiments, some components may be duplicated (e.g., separate storage 903 for the different RATs) and some components may be reused (e.g., the same antenna 901a may be shared by the RATs).

The processor 902 may be a combination of one or more of a microprocessor, controller, microcontroller, central processing unit, digital signal processor, application specific integrated circuit, field programmable gate array, or any other suitable computing device, resource, or combination of hardware, software and/or encoded logic operable to provide, either alone or in conjunction with other network node 900 components, such as storage 903, network node 900 functionality. For example, processor 902 may execute instructions stored in storage 903. Such functionality may include providing various wireless features discussed herein to a wireless device, such as the wireless device 910, including any of the features or benefits disclosed herein.

Storage 903 may comprise any form of volatile or non-volatile computer readable memory including, without limitation, persistent storage, solid state memory, remotely mounted memory, magnetic media, optical media, random access memory (RAM), read-only memory (ROM), removable media, or any other suitable local or remote memory component. Storage 903 may store any suitable instructions, data or information, including software and encoded logic, utilized by the network node 900. The storage 903 may be used to store any calculations made by the processor 902 and/or any data received via the interface 901.

The network node 900 also comprises the interface 901 which may be used in the wired or wireless communication of signalling and/or data between network node 900, network 920, and/or wireless device 910. For example, the interface 901 may perform any formatting, coding, or translating that may be needed to allow network node 900 to send and receive data from the network 920 over a wired connection. The interface 901 may also include a radio transmitter and/or receiver that may be coupled to or a part of the antenna 901a. The radio may receive digital data that is to be sent out to other network nodes or wireless devices via a wireless connection. The radio may convert the digital data into a radio signal having the appropriate channel and bandwidth parameters. The radio signal may then be transmitted via antenna 901a to the appropriate recipient (e.g., the wireless device 910).

The antenna 901a may be any type of antenna capable of transmitting and receiving data and/or signals wirelessly. In some embodiments, antenna 901a may comprise one or more omnidirectional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line-of-sight antenna used to transmit/receive radio signals in a relatively straight line. The antenna 901a may comprise one or more elements for enabling different ranks of SIMO, MISO or MIMO operation.

The wireless device 910 may be any type of communication device, wireless device, UE, D2D device or ProSe UE, station (STA), etc. but may in general be any device, sensor, smart phone, modem, laptop, Personal Digital Assistant (PDA), tablet, mobile terminal, smart phone, laptop embedded equipped (LEE), laptop mounted equipment (LME), Universal Serial Bus (USB) dongles, machine type UE, UE capable of machine to machine (M2M) communication, etc., which is able to wirelessly send and receive data and/or signals to and from a network node, such as network node 900 and/or other wireless devices. In particular, the wireless device 910 is capable of communication as demonstrated above, e.g. in a . . . context. The wireless device 910 comprises a processor 912, storage 913, interface 911, and antenna 911a. Like the network node 900, the components of the wireless device 910 are depicted as single boxes located within a single larger box, however in practice a wireless device may comprises multiple different physical components that make up a single illustrated component (e.g., storage 913 may comprise multiple discrete microchips, each microchip representing a portion of the total storage capacity).

The processor 912 may be a combination of one or more of a microprocessor, controller, microcontroller, central processing unit, digital signal processor, application specific integrated circuit, field programmable gate array, or any other suitable computing device, resource, or combination of hardware, software and/or encoded logic operable to provide, either alone or in combination with other wireless device 910 components, such as storage 913, wireless device 910 functionality. Such functionality may include providing various wireless features discussed herein, including any of the features or benefits disclosed herein.

The storage 913 may be any form of volatile or non-volatile memory including, without limitation, persistent storage, solid state memory, remotely mounted memory, magnetic media, optical media, random access memory (RAM), read-only memory (ROM), removable media, or any other suitable local or remote memory component. The storage 913 may store any suitable data, instructions, or information, including software and encoded logic, utilized by the wireless device 910. The storage 913 may be used to store any calculations made by the processor 912 and/or any data received via the interface 911.

The interface 911 may be used in the wireless communication of signalling and/or data between the wireless device 910 and the network nodes 900, 900a. For example, the interface 911 may perform any formatting, coding, or translating that may be needed to allow the wireless device 910 to send and receive data to/from the network nodes 900, 900a over a wireless connection. The interface 911 may also include a radio transmitter and/or receiver that may be coupled to or a part of the antenna 911a. The radio may receive digital data that is to be sent out to e.g., the network node 901 via a wireless connection. The radio may convert the digital data into a radio signal having the appropriate channel and bandwidth parameters. The radio signal may then be transmitted via the antenna 911a to e.g., the network node 900.

The antenna 911a may be any type of antenna capable of transmitting and receiving data and/or signals wirelessly. In some embodiments, antenna 911a may comprise one or more omnidirectional, sector or panel antennas operable to transmit/receive radio signals between 2 GHz and 66 GHz. For simplicity, antenna 911a may be considered a part of interface 911 to the extent that a wireless signal is being used. The antenna 911a may comprise one or more elements for enabling different ranks of SIMO, MISO or MIMO operation.

In some embodiments, the components described above may be used to implement one or more functional modules used for enabling measurements as demonstrated above. The functional modules may comprise software, computer programs, sub-routines, libraries, source code, or any other form of executable instructions that are run by, for example, a processor. In general terms, each functional module may be implemented in hardware and/or in software. Preferably, one or more or all functional modules may be implemented by the processors 912 and/or 902, possibly in cooperation with the storage 913 and/or 903. The processors 912 and/or 902 and the storage 913 and/or 903 may thus be arranged to allow the processors 912 and/or 902 to fetch instructions from the storage 913 and/or 903 and execute the fetched instructions to allow the respective functional module to perform any features or functions disclosed herein. The modules may further be configured to perform other functions or steps not explicitly described herein but which would be within the knowledge of a person skilled in the art.

Certain aspects of the inventive concept have mainly been described above with reference to a few embodiments. However, as is readily appreciated by a person skilled in the art, embodiments other than the ones disclosed above are equally possible and within the scope of the inventive concept. Similarly, while a number of different combinations have been discussed, all possible combinations have not been disclosed. One skilled in the art would appreciate that other combinations exist and are within the scope of the inventive concept. Moreover, as is understood by the skilled person, the herein disclosed embodiments are as such applicable also to other standards and communication systems and any feature from a particular figure disclosed in connection with other features may be applicable to any other figure and or combined with different features.

1. A method of sensing through observing radio channel properties in a radio communication network, the method being performed by a responding station operating in the radio communication network, transmission operations in the radio communication network being performed in lower layers comprising physical layer and data link layer, and higher layers comprising layers above the data link layer, the method comprising:
receiving an initiating message from an initiating station, the initiating message comprising attributes, the attributes being obtained from lower layers of the initiating message, for a sensing operation;
receiving, through at least one sensing station associated with the responding station, at least one signal transmitted over at least one radio channel in the radio communication network; and
causing transmission of a response message comprising response information based on radio channel properties of the at least one radio channel, the response information being comprised in higher layers of the response message and what information the response message holds depends on the attributes for the sensing operation.

2. The method of claim 1, wherein the attributes for the sensing operation include an indication on a measurement report, and the response information is formed as a report type according to the measurement report.

3. The method of claim 2, wherein the attributes comprise an indicator for indicating whether the measurement report is proprietary and type information about the report type of the measurement report.

4. (canceled)

5. The method of claim 3, wherein the type information about the report type of the measurement report indicates that received samples corresponding to reference signals are to be included in the response.

6. The method of claim 3, wherein the type information about the report type of the measurement report indicates that a processed result of the radio channel properties is to be included in the response information and that the response information with the processed result is only to be sent when criteria of the processed result is achieved.

7. (canceled)

8. The method claim 1, wherein the responding station is a sensing station.

9. The method claim 1, wherein the transmission of a response message is performed in form of a broadcast message.

10. The method claim 1, wherein the transmission of a response message is performed in form of any one of a multi-cast message and one or more unicast messages, and wherein the multi-cast or unicast messages are addressing entities based on a subscription.

11. (canceled)

12. The method claim 1, wherein the causing of the transmission of response information is halted until a change of response in view of a prior transmitted response exists.

13. A wireless device comprising a transceiver and a controller, transmission operations being performed in lower layers comprising physical layer and data link layer, and higher layers comprising layers above the data link layer, the controller being configured to cause the wireless device to perform, by the transceiver:
receiving an initiating message from an initiating station, the initiating message comprising attributes, the attributes being obtained from lower layers of the initiating message, for a sensing operation;
receiving, through at least one sensing station associated with the responding station, at least one signal transmitted over at least one radio channel in the radio communication network; and
causing transmission of a response message comprising response information based on radio channel properties of the at least one radio channel, the response information being comprised in higher layers of the response message and what information the response message holds depends on the attributes for the sensing operation.

14. A method of initiating sensing, which sensing is performed through observing, by a sensing station, radio channel properties in a radio communication network, the method being performed by an initiating station operating in the radio communication network, transmission operations in the radio communication network being performed in lower layers comprising physical layer and data link layer, and higher layers comprising layers above the data link layer, the method comprising:
transmitting an initiating message from an initiating station to a responding station associated with the sensing station, the initiating message comprising attributes for a sensing operation, the attributes being comprised in lower layers of the initiating message; and
causing at least one transmitting station to transmit at least one signal over at least one radio channel in the radio communication network.

15. The method of claim 14, wherein the attributes for the sensing operation indicates a response message form where response information is comprised in higher layers of a response message.

16. The method of claim 14, comprising:
receiving a response message comprising response information from the responding station or a sensing station, where the response information has form based on the attributes for the sensing operation and the response information is comprised in higher layers of the response message.

17. The method claim 14, wherein the attributes for the sensing operation include an indication on a measurement report, and the response has form as a report type according to the measurement report.

18. The method of claim 17, wherein the attributes comprise an indicator for indicating whether the measurement report is proprietary and comprise type information about the report type of the measurement report.

19. (canceled)

20. The method of claim 18, wherein the type information indicates that received samples corresponding to reference signals are to be included in the response.

21. The method of claim 18, wherein the type information indicates that a processed result of the radio channel properties is to be included in the response and that the response with the processed result is only to be sent when criteria of the processed result are achieved.

22. (canceled)

23. The method claim 14, wherein the initiating station is also the transmitting station and the responding station is also the sensing station.

24. (canceled)

25. The method claim 14, wherein the responding station is an access point station and the sensing station comprises one or more stations associated with a basic service set of the access point.

26. (canceled)

27. A wireless device comprising a transceiver and a controller, transmission operations being performed in lower layers comprising physical layer and data link layer, and higher layers comprising layers above the data link layer, the controller being configured to cause the wireless device to perform, by the transceiver:
transmitting an initiating message from an initiating station to a responding station associated with the sensing station, the initiating message comprising attributes for a sensing operation, the attributes being comprised in lower layers of the initiating message; and
causing at least one transmitting station to transmit at least one signal over at least one radio channel in the radio communication network.

28-42. (canceled)
